(19) United States
(12) Patent Application Publication
(10) Pub. No.: US 2022/0318120 A1
(43) Pub. Date: Oct. 6, 2022

(54) PROVIDING CONTENT WHILE LOADING

(71) Applicant: Citrix Systems, Inc., Fort Lauderdale, FL (US)

(72) Inventor: Wu Hao, Nanjing (CN)

(21) Appl. No.: 17/239,748

(22) Filed: Apr. 26, 2021

Related U.S. Application Data
(63) Continuation of application No. PCT/CN2021/084208, filed on Mar. 31, 2021.

(51) Int. Cl. G06F 11/34; G06F 3/0481

(52) U.S. Cl. CPC G06F 11/3419; G06F 3/0481

(57) ABSTRACT

A method may include receiving, by a first computing system and from a client device, a request to access first content. The method may further include initiating, by the first computing system and in response to receiving the request, loading of the first content for the client device. The method may also include receiving, by the first computing system and from a second computing system, second content to be consumed from the client device while the first content is being loaded. The method may additionally include sending, by the first computing system to the client device, a representation of the second content. Furthermore, the method may include causing, by the first computing system, the first content to be rendered by the client device.

### CROSS-REFERENCE TO RELATED APPLICATIONS

This application is a continuation of and claims the benefit under 35 U.S.C. § 120 and 35 U.S.C. § 365(c) to International Application PCT/CN2021/084208, entitled PROVIDING CONTENT WHILE LOADING, with an international filing date of Mar. 31, 2021, the entire contents of which are incorporated herein by reference for all purposes.

### BACKGROUND

Content such as desktops, applications, or files may take a long time to load. For example, virtual desktops or applications may have long load times as various resources are accessed. A user attempting to access the content may be left waiting, anxious about when the content will load. In some cases, the load times for the content may not be easily improved or may not be improvable in a meaningful way, and the user may be left waiting anxiously each time he or she attempts to access the content.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method may include receiving, by a first computing system and from a client device, a request to access first content. The method may further include initiating, by the first computing system and in response to receiving the request, loading of the first content for the client device. The method may also include receiving, by the first computing system and from a second computing system, second content to be consumed from the client device while the first content is being loaded. The method may additionally include sending, by the first computing system to the client device, a representation of the second content. Furthermore, the method may include causing, by the first computing system, the first content to be rendered by the client device.

In some disclosed embodiments, a first system may include at least one processor and at least one computer-readable medium encoded with instructions which, when executed by the at least one processor, cause the first computing system to receive, from a client device, a request to access first content. The at least one computer-readable medium may be further encoded with additional instructions which, when executed by the at least one processor, further cause the first computing system to initiate, in response to receiving the request, loading of the first content for the client device. The at least one computer-readable medium may be further encoded with additional instructions which, when executed by the at least one processor, also cause the first computing system to receive, from a second computing system, second content to be consumed from the client device while the first content is being loaded. The at least one computer-readable medium may be further encoded with additional instructions which, when executed by the at least one processor, additionally cause the first computing system to send, to the client device, a representation of the second content. The at least one computer-readable medium may be further encoded with additional instructions which, when executed by the at least one processor, further cause the first computing system to cause the first content to be rendered by the client device.

In some disclosed embodiments, a method may include sending, from a client device to a first remote computing system, a request to access first content that is accessible via the first remote computing system. The method may further include receiving, by the client device and from the first remote computing system, second content to be rendered while the first content is being loaded by the first remote computing system. The second content may have been received by the first remote computing system from a second remote computing system. The method may also include rendering, by the client device, the second content while the first content is being loaded by the first remote computing system. The method may additionally include rendering, by the client device and after the first content has been loaded by the first remote computing system, the first content.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A is a block diagram showing example features of an illustrative content provisioning system in accordance with some aspects of the present disclosure;

FIG. 1B depicts an example graphical user interface (GUI) of content provisioning systems in accordance with some aspects of the present disclosure;

FIG. 1C depicts another example GUI of content provisioning systems in accordance with some aspects of the present disclosure;

FIG. 1D depicts another example GUI of content provisioning systems in accordance with some aspects of the present disclosure;

FIG. 1E depicts another example GUI of content provisioning systems in accordance with some aspects of the present disclosure;

FIG. 1F depicts another example GUI of content provisioning systems in accordance with some aspects of the present disclosure;

FIG. 2 is a diagram of a network environment in which some components of content provisioning systems disclosed herein may be deployed;

FIG. 3 is a diagram of an example computing system that may be used to implement one or more components of the network environment shown in FIG. 2;

FIG. 4 is a diagram of a cloud computing environment in which various aspects of the disclosure may be implemented;

FIG. 5A is a block diagram of an example system in which resource management services may manage and streamline access by clients to resource feeds (via one or more gateway services) and/or software-as-a-service (SaaS) applications;

FIG. 5B is a block diagram showing an example implementation of the system shown in FIG. 5A in which various resource management services as well as a gateway service are located within a cloud computing environment;

FIG. 5C is a block diagram similar to that shown in FIG. 5B but in which the available resources are represented by a single box labeled “systems of record,” and further in which several different services are included among the resource management services;

FIG. 5D shows how a display screen may appear when an intelligent activity feed feature of a multi-resource management system, such as that shown in FIG. 5C, is employed;

FIG. 6 shows an example content provisioning process involving example operations in accordance various aspects of the disclosure;

FIG. 7 shows a sequence diagram illustrating an example workflow involving the example content provisioning system shown in FIG. 1; and

FIG. 8 also shows an example content provisioning process involving example operations in accordance various aspects of the disclosure.

### DETAILED DESCRIPTION

For purposes of reading the description of the various embodiments below, the following descriptions of the sections of the specification and their respective contents may be helpful:

Section A provides an introduction to example embodiments of content provisioning systems configured in accordance with some aspects of the present disclosure;

Section B describes a network environment which may be useful for practicing embodiments described herein;

Section C describes a computing system which may be useful for practicing embodiments described herein;

Section D describes a cloud computing environment which may be useful for practicing embodiments described herein;

Section E describes embodiments of systems and methods for managing and streamlining access by clients to a variety of resources;

Section F provides a more detailed description of example embodiments of the content provisioning systems introduced above in Section A; and

Section G describes example implementations of methods, systems/devices, and computer-readable media in accordance with the present disclosure.

### A. Introduction to Illustrative Embodiments of Content Provisioning Systems

Various content including desktops, applications, and files may be provided to or accessed by local user computing devices or endpoints from remote systems. Some products and services included in the Citrix Workspace™ family of products offered by Citrix Systems, Inc., of Fort Lauderdale, Fla., may provide such remote access to desktops, applications, and files. For example, a virtual desktop may be provided from a remote system and accessed from an endpoint via a virtual channel (e.g., via a High-Definition User Experience (HDX)/Independent Computing Architecture (ICA) display remoting protocol). A virtual desktop session may be delivered from the remote system as a service to the endpoint (e.g., a user computing device) along with various applications used on the virtual desktop.

Accessing content at local user computing devices from remote systems may involve waiting for the content to load. Wait times may be relatively long and may be caused by system performance, network bandwidth (or other network issues), or load times at the remote systems. Users may not wish to wait long periods of time for the content to load and may feel anxious during wait times. In some cases, these long wait times are difficult or impossible to resolve or improve and may contribute to a negative user experience.

Systems and methods for providing content while loading are described herein. In order to improve user experience during wait times due to loading desired content (e.g., first content such as desktops, applications, files, or search results), different content (e.g., second content related to tasks or information for a user) may be provided and consumed by the user while the user waits for the desired content to load. User experience may be improved as the user will have something to do during the wait time. In this way, the wait time may be transformed into meaningful, productive time for the user.

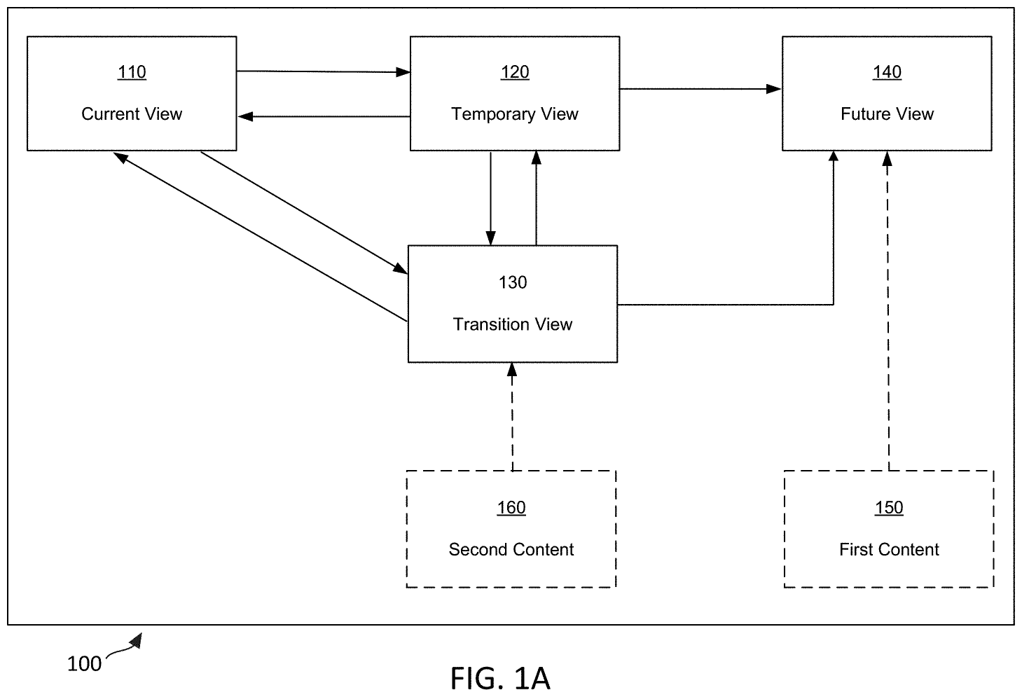

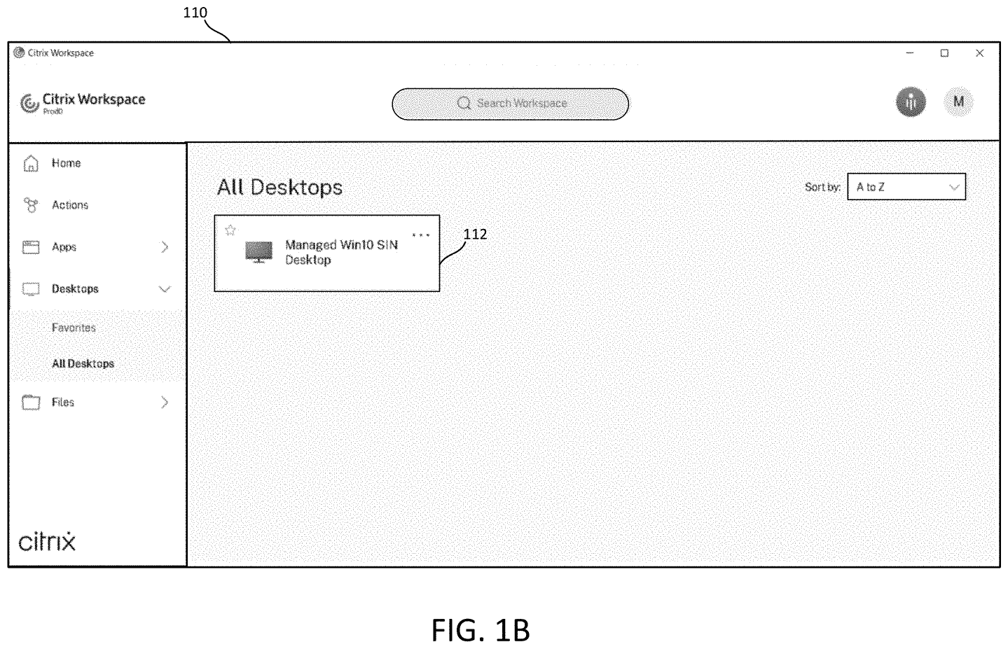

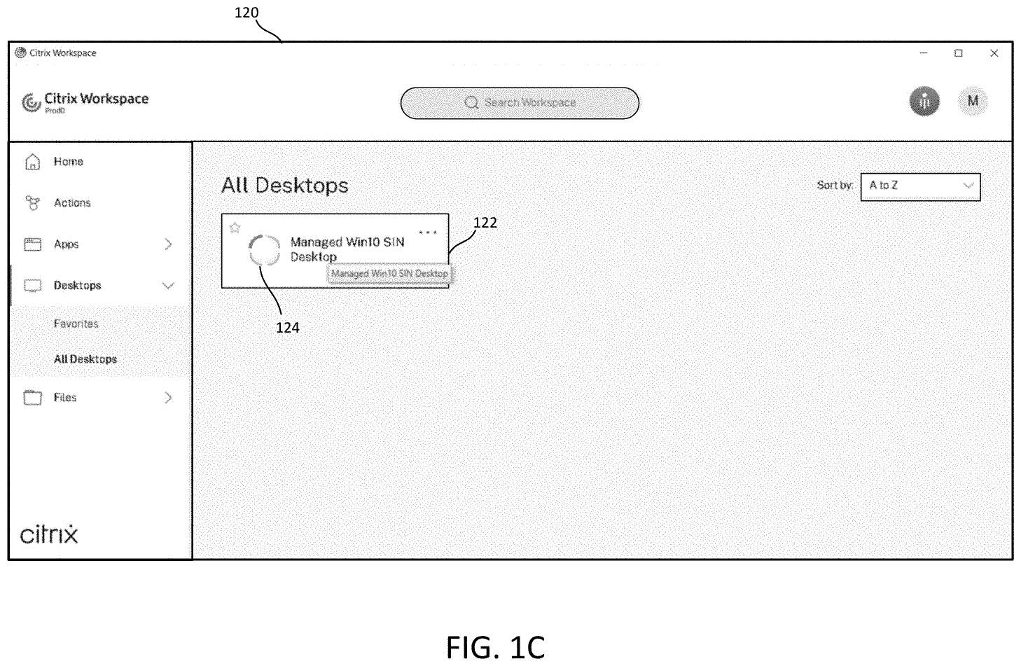

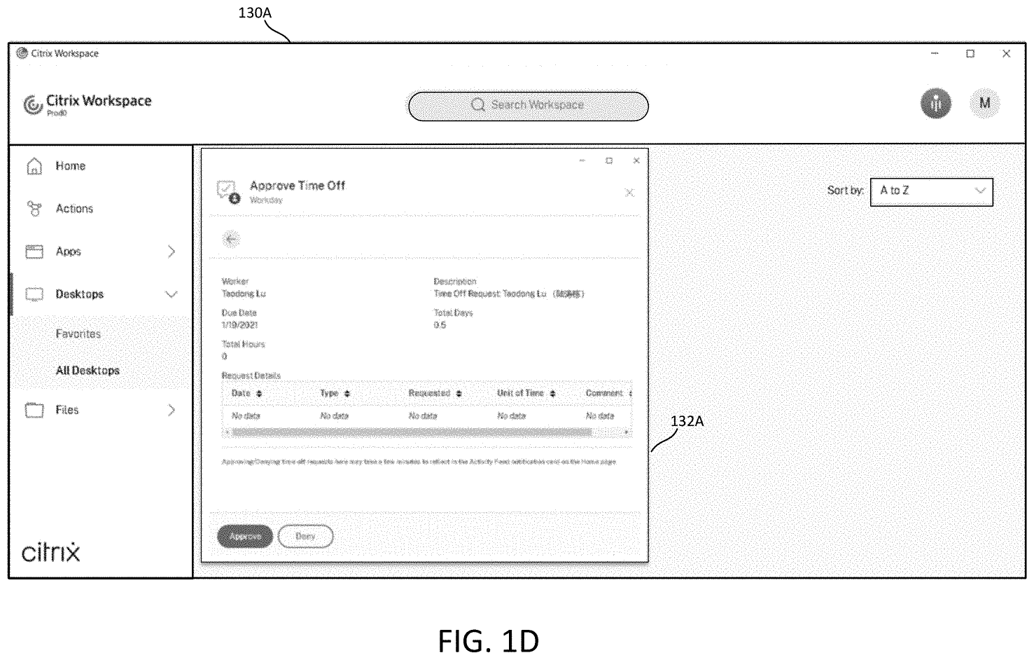

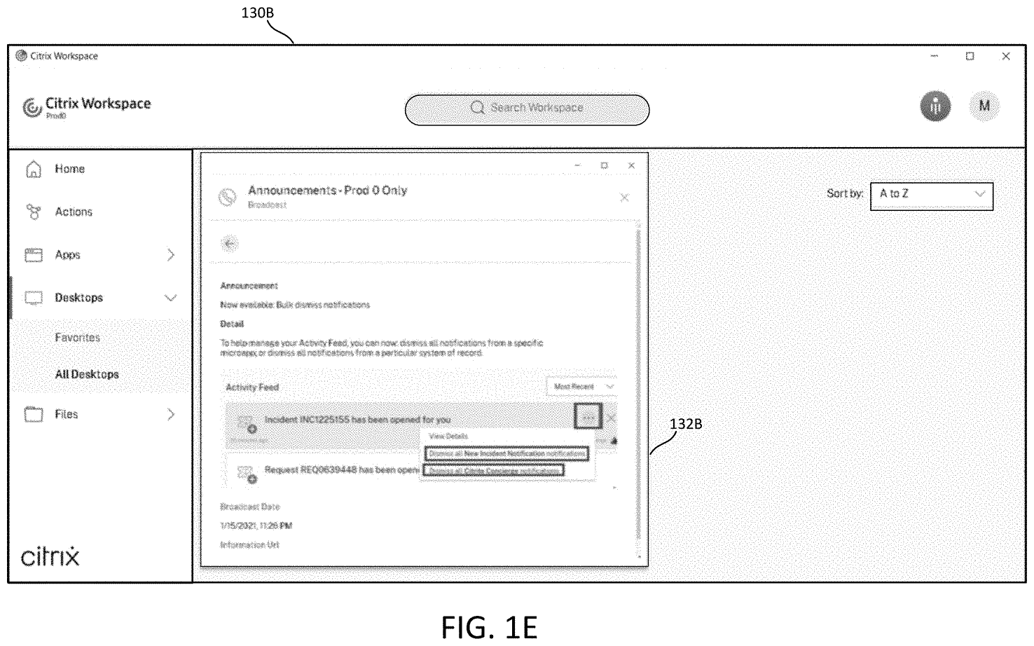

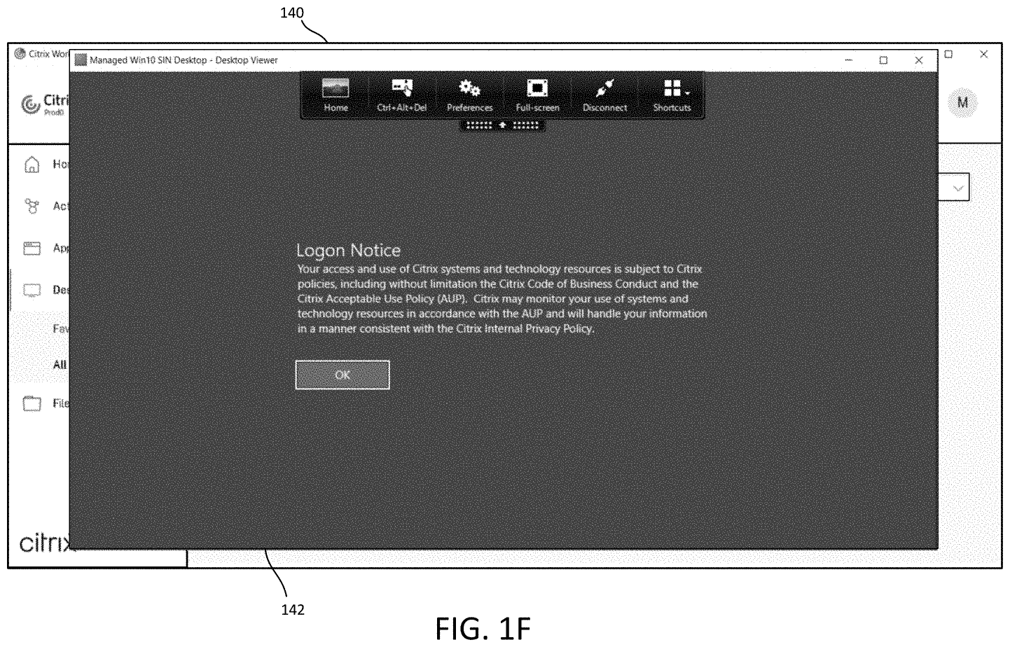

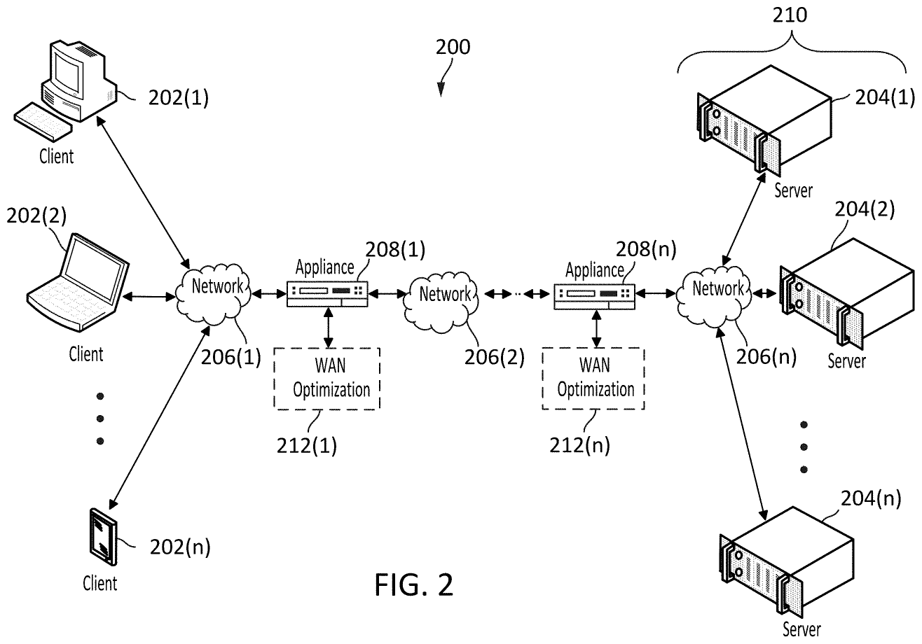

Referring now to FIG. 1A, a block diagram showing example features of an illustrative content provisioning system 100 in accordance with some aspects of the present disclosure is shown. The system 100 may be a client device (e.g., client device 202(1)-202(n) as shown in FIG. 2). The client device may be a local user computing device or endpoint and may render or display various GUIs from which the user can request and access content (e.g., remote content). As shown in FIG. 1A, the content accessed by such GUIs may include first content 150 as well as second content 160 which is different than the first content 150. The GUIs may provide various views from which the user may request and access the content 150, 160. For example, a current view 110 may be rendered or displayed by the system 100 and may show the first content 150 that is accessible from the system 100 such as various desktops, applications, or files.

Referring now to FIG. 1B, an example of the current view 110 is shown. In some implementations, the current view 110 may be a GUI provided by an intelligent workspace platform such as Citrix Workspace™. As shown in FIG. 1B, the current view 110 may provide access to a desktop (e.g., via an icon 112). Such a desktop may, for example, correspond to the first content 150 shown in FIG. 1A. The desktop may be a virtual desktop as discussed above, such as a Citrix Workspace™ desktop. A user of the system 100 may select the icon 112 to access the desktop. As discussed above, the user may experience a long wait time while the desktop loads and is rendered or displayed by the system 100.

Referring now to FIGS. 1C and 1F, upon selection of the icon 112 to access the desktop, the system 100 may render or display a temporary view 120 (e.g., as shown in FIG. 1C) or a future view 140 (e.g. as shown in FIG. 1F). The temporary view 120 and the future view 140 may be GUIs provided by the intelligent workspace platform such as the Citrix Workspace™. The temporary view 120 may be rendered or displayed, for example, to indicate progress while the first content 150, e.g., a desktop (or other selected content such as an application or file), is loading. As shown in FIG. 1C, progress may be indicated by a progress indicator 124 which may appear inside an icon 122. The progress indicator 124 may be a rotating circle as shown in FIG. 1C, but this is shown for illustrative purposes only as the progress indicator may take on other forms, e.g., a bar or other shape or graphic, and may appear in other areas of the temporary view 120.

In situations where the load time happens to be very short (which may be more likely for loading an application or file than a desktop), the system 100 may render or display the future view 140 with the loaded first content 150 (e.g., a desktop 142 or other selected content that has loaded) upon selection of the icon 112 without displaying the temporary view 120. In other situations with longer load times, the system 100 may render or display the temporary view 120 while the first content 150 (e.g., the desktop 142) loads and then render or display the future view 140 after the first content 150 has loaded.

As discussed above, wait times for loading the first content 150, such as the desktop 142, may be long and may cause the user to feel anxious. For example, the user may be stuck looking at the temporary view 120 and/or the progress indicator 124 for extended periods of time while the first content 150 loads. Referring now to FIG. 1D, in situations with longer wait times, the system 100 may render or display a transition view 130A. The transition view 130A may, for example, be a GUI provided by an intelligent workspace platform such as the Citrix Workspace™. The transition view 130A may provide the second content 160, e.g., tasks or information for the user to consume, while the user waits for the first content 150 (e.g., the desktop 142) to load. For example, a pop-up 132A may be rendered or displayed with the transition view 130A and may provide one or more tasks that allow the user to make meaningful and productive use of the wait time during which the first content 150 loads. The pop-up 132A may allow the user to perform an action or function such as approve time off for employees, take a survey, work on a to-do list, etc.

The transition view 130A presenting the second content 160 may be launched after the current view 110 upon the selection of the first content 150 (e.g., via the icon 112) if it is initially determined that the wait time will be long. Further, the transition view 130A may also be launched after the temporary view 120 if it is determined during loading of the first content 150 (e.g., the desktop 142) that the wait time will be long. Additionally, referring also to FIG. 1E, another transition view 130B presenting additional second content 160 may be launched after the transition view 130A if the first content 150 is still loading after consumption of the pop-up 132A by the user. The transition view 130B may similarly be a GUI provided by an intelligent workspace platform such as the Citrix Workspace™. A pop-up 132B may be rendered or displayed with the transition view 130B. The pop-up 132B may provide the additional second content 160, e.g., information for the user to view such as an announcement, news, etc., and may allow the user to make meaningful and productive use of the wait time during which the first content 150 loads. In some implementations, even further transition views 130 presenting even more second content 160 may continue to be presented to keep the user busy as he or she waits for the first content 150 to load.

It should be noted that the pop-ups 132A and 132B are provided for illustrative purposes only and other types of second content 160 and/or forms of providing second content 160 to be consumed during the wait time are within the scope of the present disclosure. Further, it should be noted that the two transition views 130A and 130B are provided for illustrative purposes only and in some situations only one transition view (or additional transition views) may be implemented and various pop-ups or other forms of providing second content 160 may be rendered or displayed.

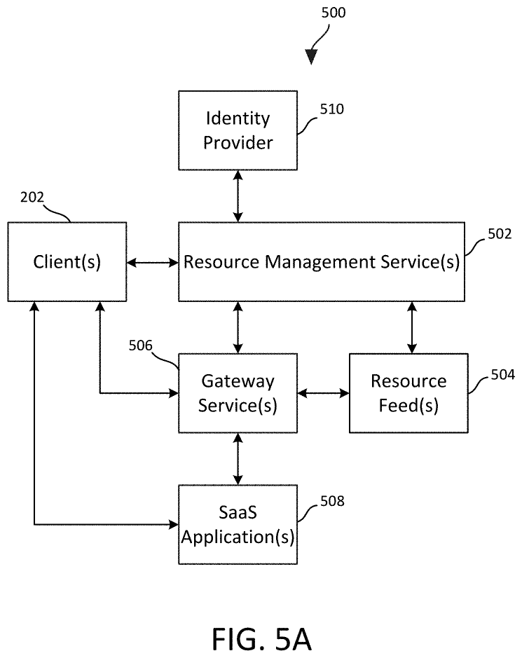

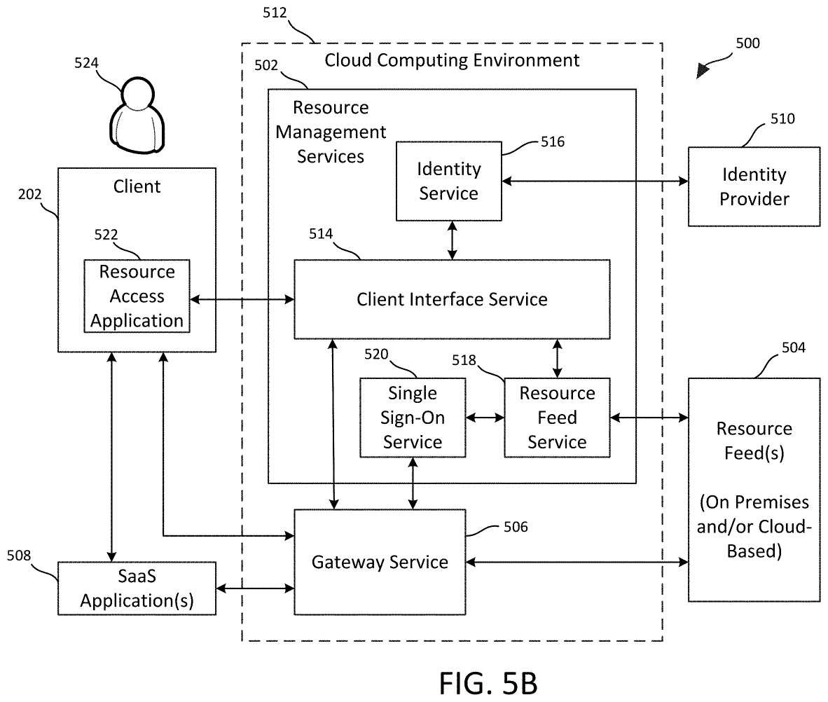

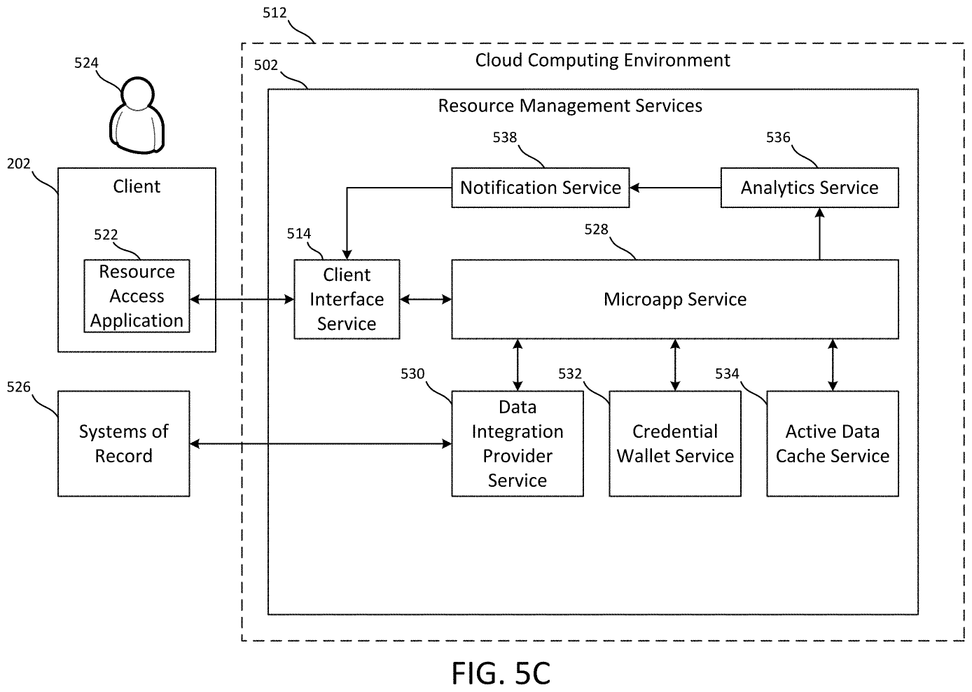

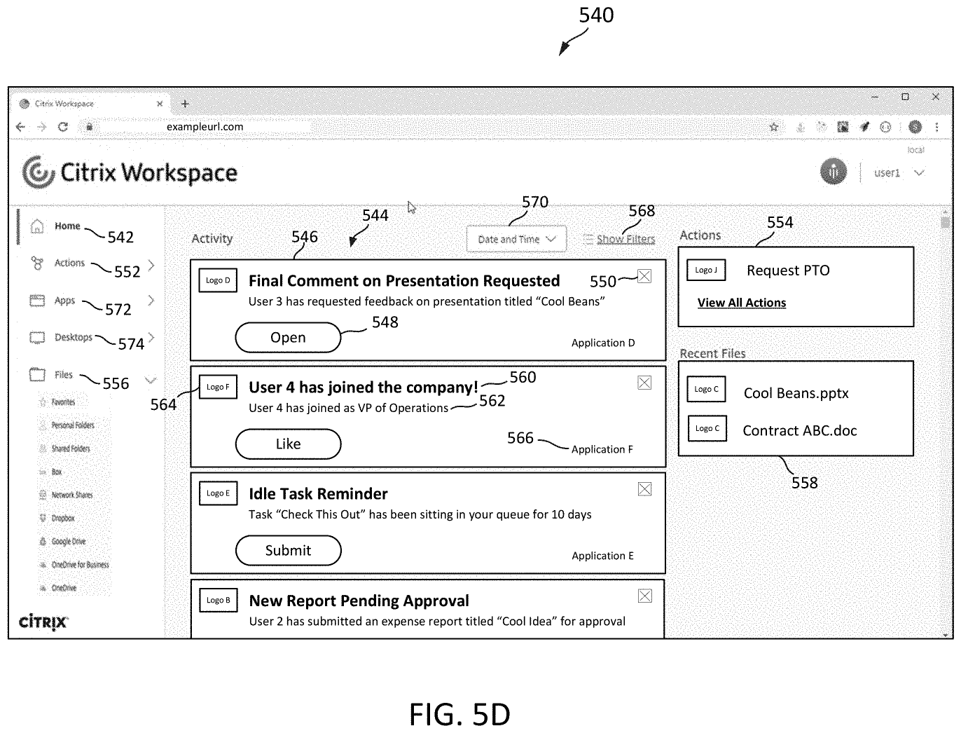

The second content 160 (e.g., tasks or other information as described above) to be consumed while waiting for loading of the selected first content 150 (e.g., a desktop, application, or file as described above) may take on any of numerous forms. In some implementations, for example, such second content 160 may be in the form of activity feed notifications (e.g., the notifications 546 described in Section E below in connection with FIG. 5D). As Section E describes, an intelligent workspace (e.g., the multi-resource access system 500 described in connection with FIGS. 5A-D) may include a service that accesses systems of record 526 resources (e.g., SaaS applications, web applications, Windows applications, Linux applications, desktops, file repositories and/or file sharing systems, and other data) on behalf of a user 524 (e.g., via application programming interfaces (APIs)) and gathers data about events or status for the user 524. The gathered data may be fed to an analytics service (e.g., the analytics service 536 as shown in FIG. 5C) which may create targeted scored notifications 546 to send the user 524 based on the events or status of the user's applications. A notification service (e.g., the notification service 538 as shown in FIG. 5C) may then push the notifications 546 to a resource access application (e.g., the resource access application 522 shown in FIGS. 5B and 5C) on a client device 202 operated by the user 524, where the notifications 546 may appear as individual notifications about the applications for the user 524.

The notifications (e.g., the notifications 546 as shown in FIG. 5D) may indicate actions for the user to take, approvals for the user to give, information about the user's meetings or events (e.g., reminders), etc. In some implementations, notifications 546 which are the most interesting, important, or appropriate for wait times during content loading (e.g., loading the desktop 142) for the user may be selected to be rendered or displayed (as the second content 160) with the transition view 130A or 130B (e.g., as pop-ups 132A or 132B or in place of pop-ups 132A or 132B). For example, in some implementations, the analytics service 536 may prioritize and sort the notifications 546 based on specific criteria (e.g., based on urgency and what is most interesting or important to the user 524 as indicated by collected data, or what is appropriate for wait times during content loading). Based on the type of notification 546, the action taken by the user 524, the history of the user 524, etc., a machine learning model or other component may score the notifications 546 (e.g., based on urgency, interest, importance, time to consume, etc.).

The inventor has recognized and appreciated that long wait times during content loading may be inevitable due to system performance and network constraints, may cause anxiety for users, and may create a negative user experience. The inventor has thus recognized and appreciated a need to improve the user experience caused by the long wait times and developed a solution to create meaningful and productive use of the long wait time for users by providing the ability to perform tasks or consume important information during the long wait times. Importantly, the inventor has recognized that second content (e.g., tasks or information) from a different system or systems than those involved in rendering or displaying first content (e.g., selected desktops, applications, or files) can be rendered or displayed for the user while the user waits for the first content to load, even when underlying system performance and network constraints cause long wait times for the first content to load.

Using the techniques and features described in the present disclosure for providing such second content while loading, improved user experience can be achieved in spite of long want times for loading the first content. By implementing one or more transition views with second content of interest to the user rendered or displayed based on wait times, time to consume the second content, user preferences for the second content, etc., the user may make meaningful and productive use of long wait times during loading of the first content.

Additional details and example implementations of embodiments of the present disclosure are set forth below in Section F, following a description of example systems and network environments in which such embodiments may be deployed.

### B. Network Environment

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one of more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, Fla., such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over interne protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, Fla., such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of an organization.

### C. Computing Environment

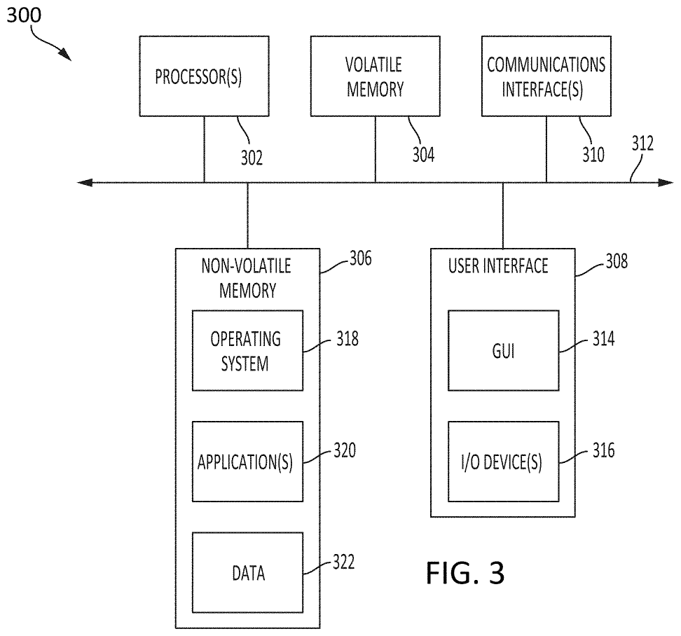

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Cloud Computing Environment

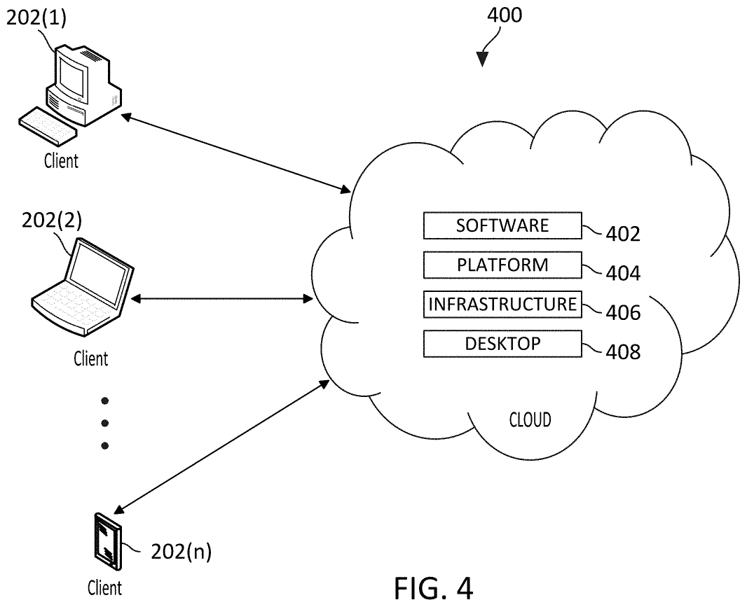

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Wash., or AMAZON WEB SERVICES provided by Amazon.com, Inc., of Seattle, Wash., for example. In the case of Citrix Cloud, Citrix Workspace app may be used as a single-entry point for bringing apps, files and desktops together (whether on-premises or in the cloud) to deliver a unified experience.

### E. Systems and Methods for Managing and Streamlining Access by Client Devices to a Variety of Resources

FIG. 5A is a block diagram of an example multi-resource access system 500 in which one or more resource management services 502 may manage and streamline access by one or more clients 202 to one or more resource feeds 504 (via one or more gateway services 506) and/or one or more software-as-a-service (SaaS) applications 508. In particular, the resource management service(s) 502 may employ an identity provider 510 to authenticate the identity of a user of a client 202 and, following authentication, identify one or more resources the user is authorized to access. In response to the user selecting one of the identified resources, the resource management service(s) 502 may send appropriate access credentials to the requesting client 202, and the client 202 may then use those credentials to access the selected resource. For the resource feed(s) 504, the client 202 may use the supplied credentials to access the selected resource via a gateway service 506. For the SaaS application(s) 508, the client 202 may use the credentials to access the selected application directly.

The client(s) 202 may be any type of computing devices capable of accessing the resource feed(s) 504 and/or the SaaS application(s) 508, and may, for example, include a variety of desktop or laptop computers, smartphones, tablets, etc. The resource feed(s) 504 may include any of numerous resource types and may be provided from any of numerous locations. In some embodiments, for example, the resource feed(s) 504 may include one or more systems or services for providing virtual applications and/or desktops to the client(s) 202, one or more file repositories and/or file sharing systems, one or more secure browser services, one or more access control services for the SaaS applications 508, one or more management services for local applications on the client(s) 202, one or more internet enabled devices or sensors, etc. The resource management service(s) 502, the resource feed(s) 504, the gateway service(s) 506, the SaaS application(s) 508, and the identity provider 510 may be located within an on-premises data center of an organization for which the multi-resource access system 500 is deployed, within one or more cloud computing environments, or elsewhere.

FIG. 5B is a block diagram showing an example implementation of the multi-resource access system 500 shown in FIG. 5A in which various resource management services 502 as well as a gateway service 506 are located within a cloud computing environment 512. The cloud computing environment may, for example, include Microsoft Azure Cloud, Amazon Web Services, Google Cloud, or IBM Cloud. It should be appreciated, however, that in other implementations, one or more (or all) of the components of the resource management services 502 and/or the gateway service 506 may alternatively be located outside the cloud computing environment 512, such as within a data center hosted by an organization.

For any of the illustrated components (other than the client 202) that are not based within the cloud computing environment 512, cloud connectors (not shown in FIG. 5B) may be used to interface those components with the cloud computing environment 512. Such cloud connectors may, for example, run on Windows Server instances and/or Linux Server instances hosted in resource locations and may create a reverse proxy to route traffic between those resource locations and the cloud computing environment 512. In the illustrated example, the cloud-based resource management services 502 include a client interface service 514, an identity service 516, a resource feed service 518, and a single sign-on service 520. As shown, in some embodiments, the client 202 may use a resource access application 522 to communicate with the client interface service 514 as well as to present a user interface on the client 202 that a user 524 can operate to access the resource feed(s) 504 and/or the SaaS application(s) 508. The resource access application 522 may either be installed on the client 202, or may be executed by the client interface service 514 (or elsewhere in the multi-resource access system 500) and accessed using a web browser (not shown in FIG. 5B) on the client 202.

As explained in more detail below, in some embodiments, the resource access application 522 and associated components may provide the user 524 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 522 is launched or otherwise accessed by the user 524, the client interface service 514 may send a sign-on request to the identity service 516. In some embodiments, the identity provider 510 may be located on the premises of the organization for which the multi-resource access system 500 is deployed. The identity provider 510 may, for example, correspond to an on-premises Windows Active Directory. In such embodiments, the identity provider 510 may be connected to the cloud-based identity service 516 using a cloud connector (not shown in FIG. 5B), as described above. Upon receiving a sign-on request, the identity service 516 may cause the resource access application 522 (via the client interface service 514) to prompt the user 524 for the user's authentication credentials (e.g., user-name and password). Upon receiving the user's authentication credentials, the client interface service 514 may pass the credentials along to the identity service 516, and the identity service 516 may, in turn, forward them to the identity provider 510 for authentication, for example, by comparing them against an Active Directory domain. Once the identity service 516 receives confirmation from the identity provider 510 that the user's identity has been properly authenticated, the client interface service 514 may send a request to the resource feed service 518 for a list of subscribed resources for the user 524.

In other embodiments (not illustrated in FIG. 5B), the identity provider 510 may be a cloud-based identity service, such as a Microsoft Azure Active Directory. In such embodiments, upon receiving a sign-on request from the client interface service 514, the identity service 516 may, via the client interface service 514, cause the client 202 to be redirected to the cloud-based identity service to complete an authentication process. The cloud-based identity service may then cause the client 202 to prompt the user 524 to enter the user's authentication credentials. Upon determining the user's identity has been properly authenticated, the cloud-based identity service may send a message to the resource access application 522 indicating the authentication attempt was successful, and the resource access application 522 may then inform the client interface service 514 of the successfully authentication. Once the identity service 516 receives confirmation from the client interface service 514 that the user's identity has been properly authenticated, the client interface service 514 may send a request to the resource feed service 518 for a list of subscribed resources for the user 524.

The resource feed service 518 may request identity tokens for configured resources from the single sign-on service 520. The resource feed service 518 may then pass the feed-specific identity tokens it receives to the points of authentication for the respective resource feeds 504. The resource feeds 504 may then respond with lists of resources configured for the respective identities. The resource feed service 518 may then aggregate all items from the different feeds and forward them to the client interface service 514, which may cause the resource access application 522 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 202, and/or one or more SaaS applications 508 to which the user 524 has subscribed. The lists of local applications and the SaaS applications 508 may, for example, be supplied by resource feeds 504 for respective services that manage which such applications are to be made available to the user 524 via the resource access application 522. Examples of SaaS applications 508 that may be managed and accessed as described herein include Microsoft Office 365 applications, SAP SaaS applications, Workday applications, etc.

For resources other than local applications and the SaaS application(s) 508, upon the user 524 selecting one of the listed available resources, the resource access application 522 may cause the client interface service 514 to forward a request for the specified resource to the resource feed service 518. In response to receiving such a request, the resource feed service 518 may request an identity token for the corresponding feed from the single sign-on service 520. The resource feed service 518 may then pass the identity token received from the single sign-on service 520 to the client interface service 514 where a launch ticket for the resource may be generated and sent to the resource access application 522. Upon receiving the launch ticket, the resource access application 522 may initiate a secure session to the gateway service 506 and present the launch ticket. When the gateway service 506 is presented with the launch ticket, it may initiate a secure session to the appropriate resource feed and present the identity token to that feed to seamlessly authenticate the user 524. Once the session initializes, the client 202 may proceed to access the selected resource.

When the user 524 selects a local application, the resource access application 522 may cause the selected local application to launch on the client 202. When the user 524 selects a SaaS application 508, the resource access application 522 may cause the client interface service 514 to request a one-time uniform resource locator (URL) from the gateway service 506 as well a preferred browser for use in accessing the SaaS application 508. After the gateway service 506 returns the one-time URL and identifies the preferred browser, the client interface service 514 may pass that information along to the resource access application 522. The client 202 may then launch the identified browser and initiate a connection to the gateway service 506. The gateway service 506 may then request an assertion from the single sign-on service 520. Upon receiving the assertion, the gateway service 506 may cause the identified browser on the client 202 to be redirected to the logon page for identified SaaS application 508 and present the assertion. The SaaS may then contact the gateway service 506 to validate the assertion and authenticate the user 524. Once the user has been authenticated, communication may occur directly between the identified browser and the selected SaaS application 508, thus allowing the user 524 to use the client 202 to access the selected SaaS application 508.

In some embodiments, the preferred browser identified by the gateway service 506 may be a specialized browser embedded in the resource access application 522 (when the resource application is installed on the client 202) or provided by one of the resource feeds 504 (when the resource access application 522 is located remotely), e.g., via a secure browser service. In such embodiments, the SaaS applications 508 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 504) for assessment of its security risk by a web filtering service. For approved URLs, the specialized browser may be permitted to access the link. For suspicious links, however, the web filtering service may have the client interface service 514 send the link to a secure browser service, which may start a new virtual browser session with the client 202, and thus allow the user to access the potentially harmful linked content in a safe environment.

In some embodiments, in addition to or in lieu of providing the user 524 with a list of resources that are available to be accessed individually, as described above, the user 524 may instead be permitted to choose to access a streamlined feed of event notifications and/or available actions that may be taken with respect to events that are automatically detected with respect to one or more of the resources. This streamlined resource activity feed, which may be customized for individual users, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to events right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 524 of something that requires the user's attention (e.g., approval of an expense report, new course available for registration, etc.).

FIG. 5C is a block diagram similar to that shown in FIG. 5B but in which the available resources (e.g., SaaS applications, web applications, Windows applications, Linux applications, desktops, file repositories and/or file sharing systems, and other data) are represented by a single box 526 labeled “systems of record,” and further in which several different services are included within the resource management services block 502. As explained below, the services shown in FIG. 5C may enable the provision of a streamlined resource activity feed and/or notification process for a client 202. In the example shown, in addition to the client interface service 514 discussed above, the illustrated services include a microapp service 528, a data integration provider service 530, a credential wallet service 532, an active data cache service 534, an analytics service 536, and a notification service 538. In various embodiments, the services shown in FIG. 5C may be employed either in addition to or instead of the different services shown in FIG. 5B. Further, as noted above in connection with FIG. 5B, it should be appreciated that, in other implementations, one or more (or all) of the components of the resource management services 502 shown in FIG. 5C may alternatively be located outside the cloud computing environment 512, such as within a data center hosted by an organization.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 522 without having to launch the native application. The system shown in FIG. 5C may, for example, aggregate relevant notifications, tasks, and insights, and thereby give the user 524 a dynamic productivity tool. In some embodiments, the resource activity feed may be intelligently populated by utilizing machine learning and artificial intelligence (AI) algorithms. Further, in some implementations, microapps may be configured within the cloud computing environment 512, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 5C, the systems of record 526 may represent the applications and/or other resources the resource management services 502 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 502, and in particular the data integration provider service 530, may, for example, support REST API, JSON, OData-JSON, and XML. As explained in more detail below, the data integration provider service 530 may also write back to the systems of record, for example, using OAuth2 or a service account.

In some embodiments, the microapp service 528 may be a single-tenant service responsible for creating the microapps. The microapp service 528 may send raw events, pulled from the systems of record 526, to the analytics service 536 for processing. The microapp service may, for example, periodically pull active data from the systems of record 526.

In some embodiments, the active data cache service 534 may be single-tenant and may store all configuration information and microapp data. It may, for example, utilize a per-tenant database encryption key and per-tenant database credentials.

In some embodiments, the credential wallet service 532 may store encrypted service credentials for the systems of record 526 and user OAuth2 tokens.

In some embodiments, the data integration provider service 530 may interact with the systems of record 526 to decrypt end-user credentials and write back actions to the systems of record 526 under the identity of the end-user. The write-back actions may, for example, utilize a user's actual account to ensure all actions performed are compliant with data policies of the application or other resource being interacted with.

In some embodiments, the analytics service 536 may process the raw events received from the microapp service 528 to create targeted scored notifications and send such notifications to the notification service 538.

Finally, in some embodiments, the notification service 538 may process any notifications it receives from the analytics service 536. In some implementations, the notification service 538 may store the notifications in a database to be later served in an activity feed. In other embodiments, the notification service 538 may additionally or alternatively send the notifications out immediately to the client 202 as a push notification to the user 524.

In some embodiments, a process for synchronizing with the systems of record 526 and generating notifications may operate as follows. The microapp service 528 may retrieve encrypted service account credentials for the systems of record 526 from the credential wallet service 532 and request a sync with the data integration provider service 530. The data integration provider service 530 may then decrypt the service account credentials and use those credentials to retrieve data from the systems of record 526. The data integration provider service 530 may then stream the retrieved data to the microapp service 528. The microapp service 528 may store the received systems of record data in the active data cache service 534 and also send raw events to the analytics service 536. The analytics service 536 may create targeted scored notifications and send such notifications to the notification service 538. The notification service 538 may store the notifications in a database to be later served in an activity feed and/or may send the notifications out immediately to the client 202 as a push notification to the user 524.

In some embodiments, a process for processing a user-initiated action via a microapp may operate as follows. The client 202 may receive data from the microapp service 528 (via the client interface service 514) to render information corresponding to the microapp. The microapp service 528 may receive data from the active data cache service 534 to support that rendering. The user 524 may invoke an action from the microapp, causing the resource access application 522 to send an action request to the microapp service 528 (via the client interface service 514). The microapp service 528 may then retrieve from the credential wallet service 532 an encrypted Oauth2 token for the system of record for which the action is to be invoked, and may send the action to the data integration provider service 530 together with the encrypted OAuth2 token. The data integration provider service 530 may then decrypt the OAuth2 token and write the action to the appropriate system of record under the identity of the user 524. The data integration provider service 530 may then read back changed data from the written-to system of record and send that changed data to the microapp service 528. The microapp service 528 may then update the active data cache service 534 with the updated data and cause a message to be sent to the resource access application 522 (via the client interface service 514) notifying the user 524 that the action was successfully completed.

In some embodiments, in addition to or in lieu of the functionality described above, the resource management services 502 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 502 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 502 may, for example, parse these requests and respond because they are integrated with multiple systems on the back-end. In some embodiments, users may be able to interact with the virtual assistant through either the resource access application 522 or directly from another resource, such as Microsoft Teams. This feature may allow employees to work efficiently, stay organized, and deliver only the specific information they're looking for.

FIG. 5D shows how a display screen 540 presented by a resource access application 522 (shown in FIG. 5C) may appear when an intelligent activity feed feature is employed and a user is logged on to the system. Such a screen may be provided, for example, when the user clicks on or otherwise selects a “home” user interface element 542. As shown, an activity feed 544 may be presented on the screen 540 that includes a plurality of notifications 546 about respective events that occurred within various applications to which the user has access rights. An example implementation of a system capable of providing an activity feed 544 like that shown is described above in connection with FIG. 5C. As explained above, a user's authentication credentials may be used to gain access to various systems of record (e.g., SalesForce, Ariba, Concur, RightSignature, etc.) with which the user has accounts, and events that occur within such systems of record may be evaluated to generate notifications 546 to the user concerning actions that the user can take relating to such events. As shown in FIG. 5D, in some implementations, the notifications 546 may include a title 560 and a body 562, and may also include a logo 564 and/or a name 566 of the system or record to which the notification 546 corresponds, thus helping the user understand the proper context with which to decide how best to respond to the notification 546. In some implementations, one or more filters may be used to control the types, date ranges, etc., of the notifications 546 that are presented in the activity feed 544. The filters that can be used for this purpose may be revealed, for example, by clicking on or otherwise selecting the “show filters” user interface element 568. Further, in some embodiments, a user interface element 570 may additionally or alternatively be employed to select a manner in which the notifications 546 are sorted within the activity feed. In some implementations, for example, the notifications 546 may be sorted in accordance with the “date and time” they were created (as shown for the element 570 in FIG. 5D), a “relevancy” mode (not illustrated) may be selected (e.g., using the element 570) in which the notifications may be sorted based on relevancy scores assigned to them by the analytics service 536, and/or an “application” mode (not illustrated) may be selected (e.g., using th 570) in which the notifications 546 may be sorted by application type.

When presented with such an activity feed 544, the user may respond to the notifications 546 by clicking on or otherwise selecting a corresponding action element 548 (e.g., “Approve,” “Reject,” “Open,” “Like,” “Submit,” etc.), or else by dismissing the notification, e.g., by clicking on or otherwise selecting a “close” element 550. As explained in connection with FIG. 5C below, the notifications 546 and corresponding action elements 548 may be implemented, for example, using “microapps” that can read and/or write data to systems of record using application programming interface (API) functions or the like, rather than by performing full launches of the applications for such systems of record. In some implementations, a user may additionally or alternatively view additional details concerning the event that triggered the notification and/or may access additional functionality enabled by the microapp corresponding to the notification 546 (e.g., in a separate, pop-up window corresponding to the microapp) by clicking on or otherwise selecting a portion of the notification 546 other than one of the user-interface elements 548, 550. In some embodiments, the user may additionally or alternatively be able to select a user interface element either within the notification 546 or within a separate window corresponding to the microapp that allows the user to launch the native application to which the notification relates and respond to the event that prompted the notification via that native application rather than via the microapp. In addition to the event-driven actions accessible via the action elements 548 in the notifications 546, a user may alternatively initiate microapp actions by selecting a desired action, e.g., via a drop-down menu accessible using the “action” user-interface element 552 or by selecting a desired action from a list 554 of recently and/or commonly used microapp actions. As shown, additional resources may also be accessed through the screen 540 by clicking on or otherwise selecting one or more other user interface elements that may be presented on the screen. For example, in some embodiments, the user may also access files (e.g., via a Citrix ShareFile™ platform) by selecting a desired file, e.g., via a drop-down menu accessible using the “files” user interface element 556 or by selecting a desired file from a list 558 of recently and/or commonly used files. Further, in some embodiments, one or more applications may additionally or alternatively be accessible (e.g., via a Citrix Virtual Apps and Desktops™ service) by clicking on or otherwise selecting an “apps” user-interface element 572 to reveal a list of accessible applications or by selecting a desired application from a list (not shown in FIG. 5D but similar to the list 558) of recently and/or commonly used applications. And still further, in some implementations, one or more desktops may additionally or alternatively be accessed (e.g., via a Citrix Virtual Apps and Desktops™ service) by clicking on or otherwise selecting a “desktops” user-interface element 574 to reveal a list of accessible desktops or by or by selecting a desired desktop from a list (not shown in FIG. 5D but similar to the list 558) of recently and/or commonly used desktops.

The activity feed shown in FIG. 5D provides significant benefits, as it allows a user to respond to application-specific events generated by disparate systems of record without needing to navigate to, launch, and interface with multiple different native applications.

### F. Detailed Description of Example Embodiments of Content Provisioning Systems and Processes

As introduced above in Section A, in accordance with some embodiments of the present disclosure, a client device 202 may be configured to present one or more transition views 130 that include second content 160 to occupy a user as the user awaits the presentation of a future view 140 that includes first content 150 that the user selected to access via a current view 110.

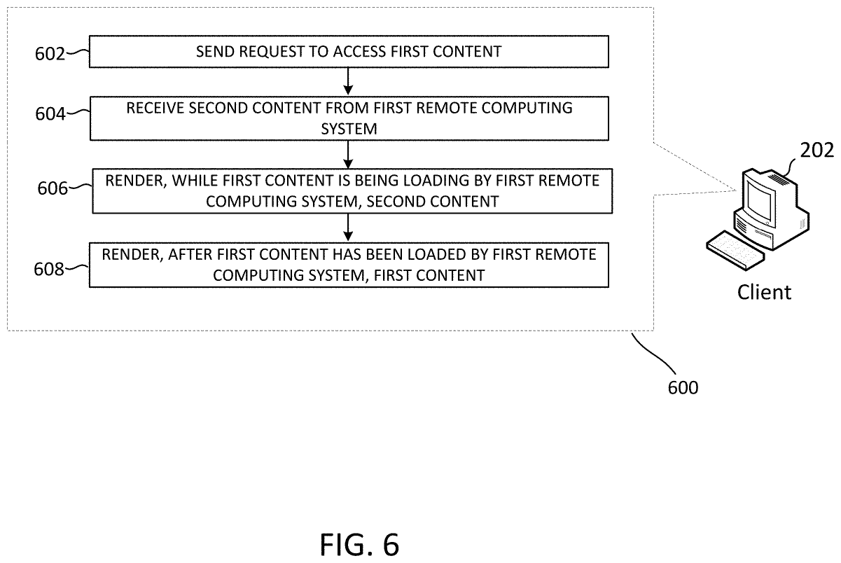

Referring now to FIG. 6, an example process 600 that may be performed by a client device 202 to achieve certain aspects of the functionality described herein is shown. Various operations are described herein as being part of the process 600. It should be appreciated, however, that not all such operations need be performed in each implementation described, and one or more of the operations may be performed in some implementations and not performed in others. In some implementations, the process 600 may include rendering a first GUI (e.g., the current view 110) indicating first content 150 (e.g., the desktop 142) that is accessible (e.g., via the icon 112). The first GUI may be rendered or displayed by the system 100, which may be, for example, a client device 202 as described above. The first content 150 may be accessible via a first remote computing system (e.g., one or more of the servers 204 described above). The process 600 may further include receiving via the first GUI (e.g., the current view 110), an indication to access the first content 150 (e.g., an indication that the icon 112 has been selected to access the desktop 142).

As shown in FIG. 6, in some implementations, the process 600 may include sending (602) a request to access the first content 150 (e.g., the desktop 142). The process 600 may further include rendering a second GUI (e.g., the temporary view 120) indicating that the first content 150 (e.g., the desktop 142) is loading. The first content 150 may be loaded from one or more remote systems (e.g., the server(s) 204), which may include the first content 150 passing over one or more networks 206 which may include the Internet.

The process 600 may further include determining that the first content 150 (e.g., the desktop 142) has not loaded after a first time period. The first time period may be configurable and may be set by the user or a system administrator based on what is considered to be a long wait time for loading content. The process 600 may also include receiving (604) second content 160 (e.g., the pop-up 130A or 130B) to be rendered while the first content 150 (e.g., the desktop 142) is being loaded by the first remote computing system (e.g., the server(s) 204). The second content 160 may be received by the client device 202 from the first remote computing system. Further, the second content 160 may have been received by the first remote computing system from a second remote computing system (e.g., one or more of the resource management services 502 or systems of record 526 as described above with regard to FIG. 5C)

Additionally, the process 600 may include rendering (606) the second content 160 (e.g., the pop-up 130A or 130B) while the first content (e.g., the desktop 142) is being loaded by the first remote computing system (e.g., the server(s) 204). The second content 160 may be rendered by the client device 202. In some implementations, rendering the second content 160 may include rendering a third GUI (e.g., the transition view 130A or 130B) providing the second content 160 (e.g., the pop-up 130A or 130B). The second content 160 may be provided for consumption while the first content 150 (e.g., the desktop 142) is loading. The third GUI may be rendered by the client device 202. Further, in some implementations, the second content 160 may be stored and loaded locally.

The first content 150 (e.g., the desktop 142) may be received from the server(s) 204 and/or over one or more networks 206 (which may include the Internet) by the client device 202. The process 600 may include rendering (608) the first content 150 after the first content 150 has been loaded by the first remote computing system (e.g., the server(s) 204). The first content 150 may be rendered by the client device 202. In some implementations, rendering the first content 150 may include rendering a fourth GUI (e.g., the future view 140). The fourth GUI may provide the first content 150 (e.g., the desktop 142) after it has loaded. The fourth GUI may be rendered by the client device 202.

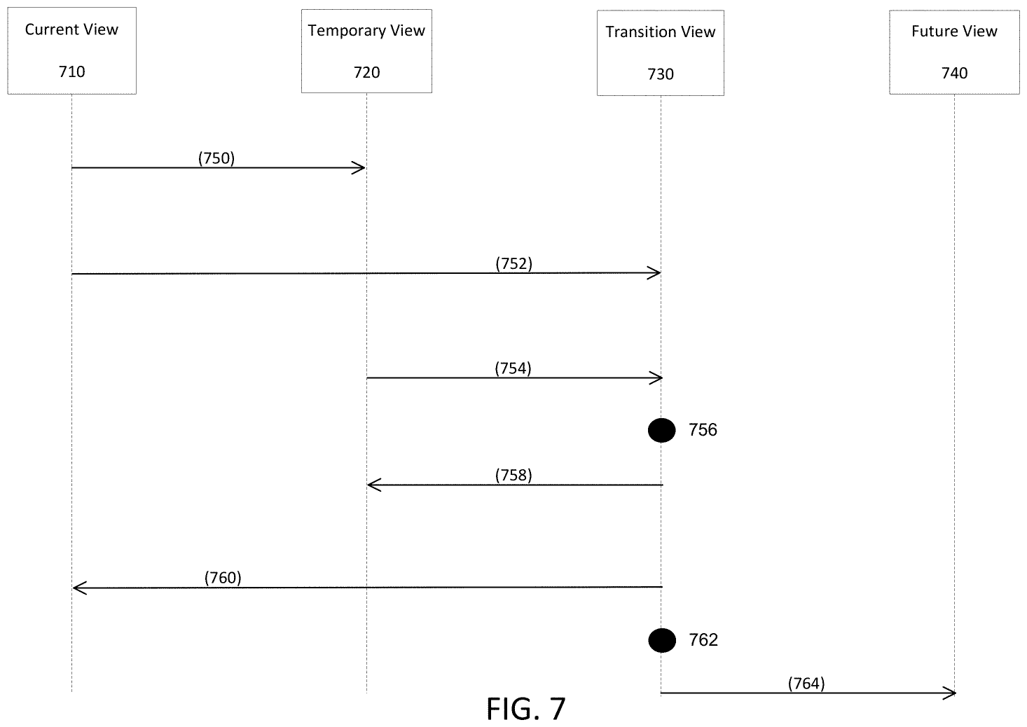

Referring now to FIG. 7, a sequence diagram illustrating an example workflow involving the example content provisioning system shown in FIG. 1 is shown. The sequence diagram shows a current view 710, a temporary view 720, a transition view 730, and a future view 740. The views 710-740 may be rendered or displayed on the system 100 (which may be a client device 202 as described above). The current view 710 may be similar to the current view 110 of FIG. 1B. The temporary view 720 may be similar to the temporary view 120 of FIG. 1C. The transition view 730 may be similar to the transition view 130A of FIG. 1D or the transition view 130B of FIG. 1E. The future view 740 may be similar to the future view 140 of FIG. 1F.

As shown in the sequence diagram, the example workflow may begin with the current view 710 being rendered or displayed. A user may select first content 150 (e.g., a desktop, an application, or a file) to access from the current view 710. While the first content 150 is loading, a temporary view 720 may be rendered (750) or displayed. The temporary view 720 may indicate progress of the loading of the first content 150. In situations where it is initially determined that there will be a long wait time for loading the first content 150, a transition view 730 may be rendered (752) or displayed without rendering or displaying the temporary view 720.

If the temporary view 720 has been rendered or displayed for too long a time, the transition view 730 may be rendered (754) or displayed. Whether the temporary view 720 has been rendered or displayed for too long a time may be based on a timer that keeps track of how long the temporary view 720 has been rendered or displayed and/or a configurable wait time that may be set by the user or the system administrator. If the timer exceeds the configurable wait time set, the transition view 730 may be rendered (754) or displayed.

In the transition view 730, second content 160, e.g., one or more tasks (such as described above with regard to the transition view 130A) or information (such as described above with regard to the transition view 130B) may be rendered (756) or displayed for the user to consume (e.g., as shown in the pop-ups 132A and 132B). The tasks or information rendered or displayed in the transition view 730 may be related to the user. For example, if the user is a manager, the transition view 730 may allow the user to process time off requests without the user having to open a separate view or application. If the user is an employee, the transition view 730 may allow the user to review a company policy without the user having to open a separate view or application.

If the user is finished with the transition view 730 (e.g., by completing the task, consuming the information, or otherwise indicating completion or desire to move on from the transition view 730), and the first content 150 is still loading, the temporary view 720 may be rendered (758) or displayed again. In situations where the temporary view 720 was not displayed because it was initially determined that the wait time would be long, the current view 710 may be rendered (760) or displayed again. The sequence may start over with operations (750) or (752) being performed again, respectively, and the temporary view 720 or the transition view 730 (e.g., including additional second content 160 or third content for the user), respectively, being rendered or displayed again

In some situations, rather than starting the sequence again, a new transition view may be rendered (762) or displayed. For example, if the user completed a task such as that shown in the transition view 130A, a new task or information such as that shown in the transition view 130B may be rendered or displayed. Similarly, if the user consumed the information such as that shown in the transition view 130B, new information or the task such as that shown in transition view 130A may be rendered or displayed.

If the user is finished with the transition view 730 and the first content 150 has loaded, the future view 740 may be rendered (764) or displayed and the user may finally access the first content 150. It should be noted that the user is not required to view, address, or consume all of the second content 160, e.g., tasks or information, presented with the transition view 730 and may move on from the transition view 730 when desired.

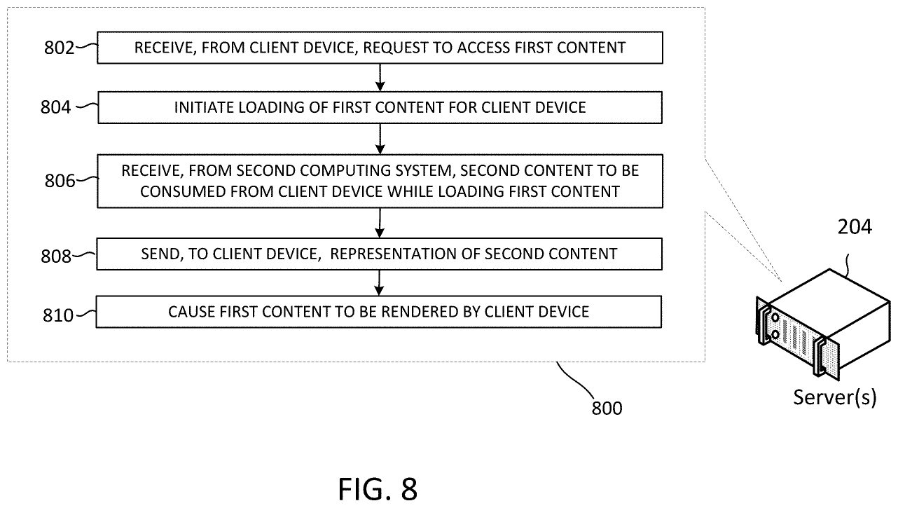

Referring now to FIG. 8, an example process 800 that may be performed by the server(s) 204 to achieve certain aspects of the functionality described herein is shown. Various operations are described herein as being part of the process 800. It should be appreciated, however, that not all such operations need be performed in each implementation described, and one or more of the operations may be performed in some implementations and not performed in others. As shown, in some implementations, the process 800 may include receiving (802) a request to access first content 150. Such a request may, for example, be received by a first computing system (e.g., the server(s) 204) from a client device 202 and may correspond to the request described above in connection with the step 602 of the process 600 (shown in FIG. 6). The first content 150 may be, for example, the desktop 142 of FIG. 1F. The request to access the first content 150 may be made by the user via the icon 112 of FIG. 1B.

The process 800 may further include initiating (804) loading of the first content 150 (e.g., the desktop 142) for the requesting client device 202. The loading of the first content 150 may be initiated by the first computing system (e.g., the server(s) 204). Initiating the loading of the first content 150 may be performed in response to receiving the request to access first content 150. In some implementations, the first content 150 may be loaded, at least in part, from one or more other computing systems, such the Citrix Virtual Apps and Desktops™ service. Such loading may include, at least in part, passing the first content 150 over one or more networks 106 which may include the Internet.

The process 800 may also include receiving (806) second content 160 to be consumed from the requesting client device 202 while the first content 150 is being loaded. The second content may be sent from a second computing system (e.g., one or more of the resource management services 502 or systems of record 526 as described above with regard to FIG. 5C) and received by the first computing system (e.g., the server(s) 204). Additionally, the process 800 may include sending (808) a representation of the second content 160 from the first computing system (e.g., the server(s) 204) to the requesting client device 202. The second content 160 may be, for example, the task or the information as shown in transition view 130A and/or transition view 130B. In some implementations, the second content 160 may be received from or may be based on data received from another computing system, such as the notification service 538 or the analytics service 536 shown in FIG. 5C.

In some implementations, the server(s) 204 may access the second content 160 from the second computing system (e.g., one or more of the resource management services 502 or systems of record 526) using access credentials associated with a user operating the requesting client device 202. Further, the server(s) 204 may cause the second content 160 (e.g., the task or information) to be rendered by the requesting client device 202 while loading the first content 150 (e.g., the desktop 142). For example, the server(s) 204 may configure the representation of the second content 160 to include a user interface element that is selectable to cause an action to be taken with respect to the second computing system. The server(s) 204 may also receive from the client device 202 an indication that the user interface element has been selected. Additionally, in response to the indication, the server(s) 204 may cause the action to be taken with respect to the second computing system.

The process 800 may include causing (810) the first content 150 (e.g., the desktop 142) to be rendered or displayed by the requesting client device 202. In some implementations, the first content 150 and/or the second content 160 may be sent from the servers(s) 204 to the requesting client device 202 via a virtual channel (e.g., via High-Definition User Experience (HDX)/Independent Computing Architecture (ICA) display remoting protocol). Thus, in such implementations, the servers(s) 204 may activate the first content 150 and/or the second content 160 and cause the first content 150 and/or the second content 160 to be rendered at the requesting client device 202 via the virtual channel. For example, in situations where the first content 150 (e.g., the desktop 142) has a long load time, the second content 160 (e.g., the task or information) may be activated by the server(s) 204 and the server(s) may cause the second content 160 to be rendered or displayed at the requesting client device 202 via the virtual channel while the first content 150 loads, e.g., via the Citrix Virtual Apps and Desktops™ service. Once the first content 150 (e.g., the desktop 142) has loaded, the server(s) 204 may activate the first content 150 and thus cause the first content 150 to be rendered at the requesting client device 202 via the virtual channel.

In some embodiments, the server(s) 204 may determine an estimated load time for the first content 150 (e.g., the desktop 142) to be renderable by the requesting client device 202. The estimated load time may be based, for example, on network bandwidth or other network factors (e.g., via a network checker). Further, the estimated load time may be based on historical data for average load times of the first content 150 or for average load times for content similar to the first content 150 (e.g., in size or location). For example, the average load time for the first content 150 over the last week, month, or year may be calculated and used to estimate the load time for the first content 150. The estimated load time may additionally or alternatively be based on querying load time information from the computing system responsible for providing the first content 150, e.g., the Citrix Virtual Apps and Desktops™ service. The estimated load time may be based, for example, on the network bandwidth/factors, the queried load time information, and/or the historical load time data.

In some implementations, the server(s) 204 may additionally or alternatively select the second content 160 (e.g., the tasks or information) based on the estimated load time for the first content 150 (e.g., the desktop 142) and an estimated consumption time for the second content 160. The estimated consumption time for the second content 160 may be based, for example, on historical data for how long it takes the user (or users in general) to perform tasks (e.g., approve/deny time off requests), to read information, etc. In some embodiments, the second content 160 may be selected from or may include one or more notifications 546 from a resource activity feed 544 (such as described above in connection with FIG. 5C and 5D).

For example, as discussed above, the activity feed 544 may be customized for individual users and may allow users to monitor important activity involving all of their resources (e.g., SaaS applications, web applications, Windows applications, Linux applications, desktops, file repositories and/or file sharing systems, and other data) through a single interface, without needing to switch context from one resource to another. As such, in some implementations, one or more notifications 546 from the user's activity feed 544, or a microapp user interface window that may be obtained by clicking or otherwise selecting such a notification 546, may be used as the second content 160 to be rendered or displayed in a transition view 130 and may be accompanied by a discrete set of user-interface elements, e.g., “approve,” “deny,” and “see more detail” buttons, allowing the user to take one or more simple actions with respect to events within the transition view 130. In some embodiments, the activity feed 544 may be enabled by one or more microapps (as described above) which may interface with underlying associated resources using APIs or the like. Actions performed by the user in the transition view 130 and in connection with such a microapp may address specific common problems and use cases quickly and easily, adding to increased user productivity (e.g., request personal time off, submit a help desk ticket, etc.) while the user waits for the first content 150 to load. In this way, the content provisioning systems and methods described herein may be integrated with the microapp service 528 described above to allow for a robust set of second content 160 to be rendered or displayed for the user while the user waits for the first content 150 to load. In some embodiments, the client device 202 and/or the server(s) 204 may be configured to provide the user with a user interface (e.g., via the resource access application 522 described in connection with FIGS. 5B and 5C) that allows the user to select which types of notifications 546 from the activity feed 544 are to be rendered or displayed as the second content 160.

As noted above, in some implementations, the server(s) 204 may generate the first content (e.g., the desktop 142) and/or the second content 160 (e.g., the tasks or information) based on the data received from one or more other computing systems, such the Citrix Virtual Apps and Desktops™ service, or one or more of the resource management services 502 or systems of record 526 as described above with regard to FIG. 5C. In some implementations, the computing system from which the server(s) 204 receive the first content 150 may be different than the computing system from which the server(s) 204 receive the second content 160. In some situations, for example, one such computing system may be able to provide the second content 160 (e.g., a notification 546) more rapidly that the other computing system is able to provide the first content 150 (e.g., the desktop 142). Further, at least in some circumstances, the second content 160 (e.g., a notification 546) may be smaller in size and/or may require less processing capacity to load than the first content 150 (e.g., the desktop 142), thus allowing the second content 160 to be rendered or displayed faster than the first content 150.

In some implementations, the server(s) 204 may determine that the first content 150 (e.g., the desktop 142) has not loaded for the requesting client device 202 after a first time period. As discussed above, the first time period may be configurable by the user or the system administrator. Sending the representation of the second content 160 to the requesting client device 202 or causing the second content 160 (e.g., the task or information) to be rendered or displayed by the requesting client device 202 may be based on determining that the first content 150 has not loaded for the requesting client device 202 after the first time period. For example, the first time period may be set at five seconds, and if the first content 150 has not loaded for the requesting client device 202 after five seconds, the server(s) 204 may cause the second content 160 to be rendered by the requesting client device 202. For example, a timer may keep track of how long the temporary view 120 has been rendered or displayed (which may indicate that the first content 150 has not yet loaded) for the requesting client device 202. If the temporary view 120 has been rendered or displayed for longer than the first time period (e.g., five seconds), then the second content 160 may be rendered or displayed on the requesting client device 202. Additionally, a counter may count how many times the temporary view 120 has been displayed to estimate how long the user has been waiting.

In some embodiments, the first content 150 may be a virtual desktop, a virtual application, or another virtual resource. The virtualization of desktops, applications, or other resources selected by the user via the client device 202 may be performed by one or more backend servers, such as by the Citrix Virtual Apps and Desktops™ service. The virtualization may consume significant processing capacity and computer resources and add to the long wait time for loading the virtual desktop, the virtual application, or the other virtual resources.

In some implementations, the server(s) 204 may receive, from the requesting client device 202, an indication that the second content 160 (e.g., the task or information) has been consumed (i.e., by the user). In response to receiving such an indication, the server(s) 204 may send third content or a representation of the third content to the client device 202. Further, the server(s) 204 may cause the third content to be rendered or displayed by the requesting client device 202 while loading the first content 150 (e.g., the desktop 142). Such third content may include a different task or information or a different notification 546 from the activity feed 544 described above. In some embodiments, the indication that the initially presented second content 160 has been consumed may include an indication by the user that the user wishes to move on from the second content 160, even if one or more tasks or information included with the initially presented second content 160 have not been addressed or viewed by the user.

In some implementations, the server(s) 204 may cause a notification to be rendered or displayed by the requesting client device 202 indicating that the first content 150 (e.g., the desktop 142) has loaded. The notification may indicate to the user that the first content 150 is ready for viewing and that the user may move on from the second content 160 (e.g., the task or information) if desired. In some embodiments, such a notification may include a form for the user to enter a username and/or password to access the first content 150. In some implementations, the server(s) 204 may further receive, from the requesting client device 202, an indication to close the second content 160 and/or to render the first content 150. Such an indication may be generated, for example, in response to a user having indicated a desire to move on from the second content 160 and/or view the first content 150. In some embodiments, causing the first content 150 to be rendered or displayed by the requesting client device 202 may be based on the indication to close the second content 160 and/or to render the first content 150.

As described above, a temporary view 120 may be rendered or displayed by the requesting client device 202 and may indicate (e.g., via the progress indicator 124) that the first content 150 (e.g., the desktop 142) is loading. In some embodiments, the server(s) 204 may cause the temporary view 120 to be rendered or displayed by the requesting client device 202 while loading the first content 150 (e.g., the desktop 142) from another computing system, e.g., the Citrix Virtual Apps and Desktops™ service. The temporary view 120 may indicate that the first content 150 is loading (e.g., via the progress indicator 124). The server(s) 204 may, for example, determine that the temporary view 120 has been rendered or displayed on the requesting client device 202 longer than a first time period (e.g., the first time period as described above). Sending the second content 160 (e.g., the tasks or information) or the representation of the second content 160 to the requesting client device 202 or causing the second content 160 to be rendered by the requesting client device 202 may be based on determining that the temporary view 120 has been rendered on the requesting client device 202 longer than the first time period.

Further, in some implementations, the server(s) 204 may receive, from the requesting client device 202, an indication that the second content 160 (e.g., the tasks or information) has been consumed (i.e., by the user). In some circumstances, in response to receiving such an indication, the server(s) 204 may cause the temporary view 120 to be rendered or displayed by the requesting client device 202. As discussed above, the temporary view 120 may indicate (e.g., via progress indicator 124) that the first content 150 (e.g., the desktop 142) is loading.

In some embodiments, if it is initially determined that network issues may cause long wait times for loading the first content 150, the second content 160 may be selected so as to only include information for the user to view or read, as responses to tasks input by the user may be slow to pass back over the network due to the network issues. Further, if the network is down or network constraints will not allow the first content 150 to be rendered or displayed by the requesting client device 202, the user may be notified that the selected content is not available at this time. Additionally, there may be a default time for loading the first content 150. For example, if loading the first content 150 normally takes thirty seconds, tasks or information that takes about thirty seconds to consume may be rendered or displayed by default, as the second content 160, in the transition view 130.

As discussed above in Section A, the content provisioning systems and methods in accordance with the present disclosure may provide several advantages, including allowing the user to turn a long wait time into a meaningful and productive time, thus allowing the user to reduce anxiety and have an improved experience. These advantages may be realized in part from implementing systems and processes as described herein.

G. Example Implementations of Methods, Systems, and Computer-Readable Media in Accordance with the Present Disclosure

The following paragraphs (M1) through (M13) describe examples of methods that may be implemented in accordance with the present disclosure.

(M1) A method may be performed that involves receiving, by a first computing system and from a client device, a request to access first content; initiating, by the first computing system and in response to receiving the request, loading of the first content for the client device; receiving, by the first computing system and from a second computing system, second content to be consumed from the client device while the first content is being loaded; sending, by the first computing system to the client device, a representation of the second content; and causing, by the first computing system, the first content to be rendered by the client device.

(M2) A method may be performed as described in paragraph (M1), and may further involve accessing, by the first computing system and using access credentials associated with a user operating the client device, the second content from the second computing system.

(M3) A method may be performed as described in paragraph (M1) or paragraph (M2), and may further involve configuring, by the first computing system, the representation of the second content to include at least one user interface element that is selectable to cause an action to be taken with respect to the second computing system.

(M4) A method may be performed as described any of paragraphs (M1) through (M3), and may further involve receiving, by the first computing system and from the client device, an indication that the at least one user interface element has been selected; and causing, by the first computing system and in response to the indication, the action to be taken with respect to the second computing system.

(M5) A method may be performed as described any of paragraphs (M1) through (M4), and may further involve determining, by the first computing system, an estimated load time for the first content to be renderable by the client device; and selecting, by the first computing system, the second content based at least in part on the estimated load time for the first content and an estimated consumption time for the second content.

(M6) A method may be performed as described any of paragraphs (M1) through (M5), and may further involve determining that the first content has not loaded on the client device after a first time period; and wherein sending the representation of the second content to the client device is based, at least in part, on determining that the first content has not loaded on the client device after the first time period.

(M7) A method may be performed as described any of paragraphs (M1) through (M6), wherein the first content is selected from the group consisting of: a desktop, a virtual desktop, an application, a virtual application, and a file.

(M8) A method may be performed as described any of paragraphs (M1) through (M7), and may further involve receiving, by the first computing system, an indication that the second content has been consumed from the client device; and sending, by the first computing system to the client device, a representation of third content, the third content to be consumed from the client device while the first content is being loaded.

(M9) A method may be performed as described any of paragraphs (M1) through (M8), and may further involve causing, at least in part by the first computing system, a notification to be rendered by the client device indicating that the first content has loaded; receiving, at least in part by the first computing system, an indication to render the first content; and wherein causing the first content to be rendered by the client is based on the indication to render the first content.

(M10) A method may be performed as described any of paragraphs (M1) through (M9), and may further involve causing, at least in part by the first computing system, a first view to be rendered by the client device while loading the first content from the first computing system, the first view indicating, at least in part, that the first content is loading; determining that the first view has been rendered on the client device longer than a first time period; and wherein sending the representation of the second content to the client device is based, at least in part, on determining that the first view has been rendered on the client device longer than the first time period.

(M11) A method may be performed as described any of paragraphs (M1) through (M10), and may further involve receiving, by the first computing system, an indication that the second content has been consumed from the client device; and causing, at least in part by the first computing system, a first view to be rendered by the client device, the first view indicating that the first content is loading

(M12) A method may be performed that involves sending, from a client device to a first remote computing system, a request to access first content that is accessible via the first remote computing system; receiving, by the client device and from the first remote computing system, second content to be rendered while the first content is being loaded by the first remote computing system, the second content having been received by the first remote computing system from a second remote computing system; rendering, by the client device, the second content while the first content is being loaded by the first remote computing system; and rendering, by the client device and after the first content has been loaded by the first remote computing system, the first content.

(M13) A method may be performed as described in paragraph (M12), and may further involve rendering, by the client device, a first graphical user interface (GUI) indicating that the first content is accessible via the first remote computing system; rendering, by the client device, a second GUI indicating, at least in part, that the first content is loading; and wherein rendering the second content includes rendering, by the client device, a third GUI providing the second content, and rendering the first content includes rendering, by the client device, a fourth GUI providing the first content.

The following paragraphs (S1) through (S13) describe examples of systems and devices that may be implemented in accordance with the present disclosure.

(S1) A first computing system may comprise at least one processor and at least one computer-readable medium encoded with instructions which, when executed by the at least one processor, cause the first computing system to receive, from a client device, a request to access first content; initiate, in response to receiving the request, loading of the first content for the client device; receive, from a second computing system, second content to be consumed from the client device while the first content is being loaded; send, to the client device, a representation of the second content; and cause the first content to be rendered by the client device.

(S2) A first computing system may be configured as described in paragraph (Si), wherein the at least one computer-readable medium may be encoded with additional instructions which, when executed by the at least one processor, further cause the first computing system to access, using access credentials associated with a user operating the client device, the second content from the second computing system.

(S3) A first computing system may be configured as described in paragraph (Si) or paragraph (S2), wherein the at least one computer-readable medium may be encoded with additional instructions which, when executed by the at least one processor, further cause the first computing system to configure the representation of the second content to include at least one user interface element that is selectable to cause an action to be taken with respect to the second computing system.

(S4) A first computing system may be configured as described in any of paragraph (S1) through (S3), wherein the at least one computer-readable medium may be encoded with additional instructions which, when executed by the at least one processor, further cause the first computing system to receive, from the client device, an indication that the at least one user interface element has been selected; and cause, in response to the indication, the action to be taken with respect to the second computing system.

(S5) A first computing system may be configured as described in any of paragraph (S1) through (S4), wherein the at least one computer-readable medium may be encoded with additional instructions which, when executed by the at least one processor, further cause the first computing system to determine an estimated load time for the first content to be renderable by the client device; and select the second content based at least in part on the estimated load time for the first content and an estimated consumption time for the second content.

(S6) A first computing system may be configured as described in any of paragraph (S1) through (S5), wherein the at least one computer-readable medium may be encoded with additional instructions which, when executed by the at least one processor, further cause the first computing system to determine that the first content has not loaded on the client device after a first time period; and wherein sending the representation of the second content to the client device is based, at least in part, on determining that the first content has not loaded on the client device after the first time period.

(S7) A first computing system may be configured as described in any of paragraph (S1) through (S6), wherein the first content is selected from the group consisting of: a desktop, a virtual desktop, an application, a virtual application, and a file.

(S8) A first computing system may be configured as described in any of paragraph (S1) through (S7), wherein the at least one computer-readable medium may be encoded with additional instructions which, when executed by the at least one processor, further cause the first computing system to receive an indication that the second content has been consumed from the client device; and send, to the client device, a representation of third content, the third content to be consumed from the client device while the first content is being loaded.

(S9) A first computing system may be configured as described in any of paragraph (S1) through (S8), wherein the at least one computer-readable medium may be encoded with additional instructions which, when executed by the at least one processor, further cause the first computing system to cause a notification to be rendered by the client device indicating that the first content has loaded; receive an indication to render the first content; and wherein causing the first content to be rendered by the client is based on the indication to render the first content.

(S10) A first computing system may be configured as described in any of paragraph (S1) through (S9), wherein the at least one computer-readable medium may be encoded with additional instructions which, when executed by the at least one processor, further cause the first computing system to cause a first view to be rendered by the client device while loading the first content, the first view indicating, at least in part, that the first content is loading; determine that the first view has been rendered on the client device longer than a first time period; and wherein sending the representation of the second content to the client device is based, at least in part, on determining that the first view has been rendered on the client device longer than the first time period.

(S11) A first computing system may be configured as described in any of paragraph (S1) through (S10), wherein the at least one computer-readable medium may be encoded with additional instructions which, when executed by the at least one processor, further cause the first computing system to receive an indication that the second content has been consumed from the client device; and cause a first view to be rendered by the client device, the first view indicating that the first content is loading.

(S12) A client device may comprise at least one processor and at least one computer-readable medium encoded with instructions which, when executed by the at least one processor, cause the client device to send, to a first remote computing system, a request to access first content that is accessible via the first remote computing system; receive, from the first remote computing system, second content to be rendered while the first content is being loaded by the first remote computing system, the second content having been received by the first remote computing system from a second remote computing system; render the second content while the first content is being loaded by the first remote computing system; and render, after the first content has been loaded by the first remote computing system, the first content.

(S13) A client device may be configured as described in paragraph (S12), wherein the at least one computer-readable medium may be encoded with additional instructions which, when executed by the at least one processor, further cause the client device to render a first graphical user interface (GUI) indicating that the first content is accessible via the first remote computing system; render a second GUI indicating, at least in part, that the first content is loading; and wherein rendering the second content includes rendering a third GUI providing the second content, and rendering the first content includes rendering a fourth GUI providing the first content.

The following paragraphs (CRM1) through (CRM13) describe examples of computer-readable media that may be implemented in accordance with the present disclosure.

(CRM1) At least one non-transitory, computer-readable medium may be encoded with instructions which, when executed by at least one processor included in a first computing system, cause the first computing system to receive, from a client device, a request to access first content; initiate, in response to receiving the request, loading of the first content for the client device; receive, from a second computing system, second content to be consumed from the client device while the first content is being loaded; send, to the client device, a representation of the second content; and cause the first content to be rendered by the client device.

(CRM2) At least one non-transitory, computer-readable medium may be configured as described in paragraph (CRM1), and may be encoded with additional instructions which, when executed by the at least one processor, further cause the first computing system to access, using access credentials associated with a user operating the client device, the second content from the second computing system.

(CRM3) At least one non-transitory, computer-readable medium may be configured as described in paragraph (CRM1) or paragraph (CRM2), and may be encoded with additional instructions which, when executed by the at least one processor, further cause the first computing system to configure the representation of the second content to include at least one user interface element that is selectable to cause an action to be taken with respect to the second computing system.

(CRM4) At least one non-transitory, computer-readable medium may be configured as described in any of paragraphs (CRM1) through (CRM3), and may be encoded with additional instructions which, when executed by the at least one processor, further cause the first computing system to receive, from the client device, an indication that the at least one user interface element has been selected; and cause, in response to the indication, the action to be taken with respect to the second computing system.

(CRM5) At least one non-transitory, computer-readable medium may be configured as described in any of paragraphs (CRM1) through (CRM4), and may be encoded with additional instructions which, when executed by the at least one processor, further cause the first computing system to determine an estimated load time for the first content to be renderable by the client device; and select the second content based at least in part on the estimated load time for the first content and an estimated consumption time for the second content.

(CRM6) At least one non-transitory, computer-readable medium may be configured as described in any of paragraphs (CRM1) through (CRM5), and may be encoded with additional instructions which, when executed by the at least one processor, further cause the first computing system to determine that the first content has not loaded on the client device after a first time period; and wherein sending the representation of the second content to the client device is based, at least in part, on determining that the first content has not loaded on the client device after the first time period.

(CRM7) At least one non-transitory, computer-readable medium may be configured as described in any of paragraphs (CRM1) through (CRM6), wherein the first content is selected from the group consisting of: a desktop, a virtual desktop, an application, a virtual application, and a file.

(CRM8) At least one non-transitory, computer-readable medium may be configured as described in any of paragraphs (CRM1) through (CRM7), and may be encoded with additional instructions which, when executed by the at least one processor, further cause the first computing system to receive an indication that the second content has been consumed from the client device; and send, to the client device, a representation of third content, the third content to be consumed from the client device while the first content is being loaded.

(CRM9) At least one non-transitory, computer-readable medium may be configured as described in any of paragraphs (CRM1) through (CRM8), and may be encoded with additional instructions which, when executed by the at least one processor, further cause the first computing system to cause a notification to be rendered by the client device indicating that the first content has loaded; receive an indication to render the first content; and wherein causing the first content to be rendered by the client is based on the indication to render the first content.

(CRM10) At least one non-transitory, computer-readable medium may be configured as described in any of paragraphs (CRM1) through (CRM9), and may be encoded with additional instructions which, when executed by the at least one processor, further cause the first computing system to cause a first view to be rendered by the client device while loading the first content, the first view indicating, at least in part, that the first content is loading; determine that the first view has been rendered on the client device longer than a first time period; and wherein sending the representation of the second content to the client device is based, at least in part, on determining that the first view has been rendered on the client device longer than the first time period.

(CRM11) At least one non-transitory, computer-readable medium may be configured as described in any of paragraphs (CRM1) through (CRM10), and may be encoded with additional instructions which, when executed by the at least one processor, further cause the first computing system to receive an indication that the second content has been consumed from the client device; and cause a first view to be rendered by the client device, the first view indicating that the first content is loading.

(CRM12) At least one non-transitory, computer-readable medium may be encoded with instructions which, when executed by at least one processor included in a client device cause the client device to send, to a first remote computing system, a request to access first content that is accessible via the first remote computing system; receive, from the first remote computing system, second content to be rendered while the first content is being loaded by the first remote computing system, the second content having been received by the first remote computing system from a second remote computing system; render the second content while the first content is being loaded by the first remote computing system; and render, after the first content has been loaded by the first remote computing system, the first content.

(CRM13) At least one non-transitory, computer-readable medium may be configured as described in paragraph (CRM12), and may be encoded with additional instructions which, when executed by the at least one processor, further cause the client device to render a first graphical user interface (GUI) indicating that the first content is accessible via the first remote computing system; render a second GUI indicating, at least in part, that the first content is loading; and wherein rendering the second content includes rendering a third GUI providing the second content, and rendering the first content includes rendering a fourth GUI providing the first content.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
receiving, by a first computing system and from a client device via a network, a request to access first content;
initiating, by the first computing system and in response to receiving the request, loading of the first content for the client device;
sending, from the first computing system to the client device via the network, second content;
after receiving the request from the client device, sending, from the first computing system to the client device via the network, a first instruction to cause the client device to present the second content while the first content is being loaded; and
causing, by the first computing system, the first content to be presented by the client device.

2. The method of claim 22, further comprising:
retrieving by the first computing system and using access credentials associated with a user operating the client device, the first data from an account of the user maintained by the second computing system;
determining, by the first computing system, that the first data is indicative of an event of the account; and
generating, by the first computing system and using the first data, the second content to be indicative of the event.

3. The method of claim 2, further comprising:
configuring, by the first computing system, the second content to include at least one user interface element that is selectable to cause an action to be taken with respect to the account.

4. The method of claim 3, further comprising:
receiving, by the first computing system and from the client device, an indication that the at least one user interface element has been selected; and
causing, by the first computing system and in response to the indication, the action to be taken with respect to the account.

5. The method of claim 1, further comprising:
determining, by the first computing system, an estimated load time for the first content to be renderable by the client device; and
after receiving the request from the client device, selecting, by the first computing system, the second content based at least in part on the estimated load time for the first content and an estimated consumption time for the second content.

6. The method of claim 1, further comprising:
determining that the first content has not loaded on the client device after a first time period;
wherein sending the first instruction to the client device is based, at least in part, on determining that the first content has not loaded on the client device after the first time period.

7. (canceled)

8. The method of claim 1, further comprising:
receiving, by the first computing system, an indication that the second content has been consumed from the client device; and
in response to the indication, sending, from the first computing system to the client device, a second instruction to cause the client device to present third content while the first content is being loaded.

9. (canceled)

10. The method of claim 1, further comprising:
causing, at least in part by the first computing system, a first view to be rendered by the client device while loading the first content from the first computing system, the first view indicating, at least in part, that the first content is being loaded; and
determining that the first view has been rendered on the client device longer than a first time period;
wherein sending the first instruction to the client device is based, at least in part, on determining that the first view has been rendered on the client device longer than the first time period.

11. The method of claim 1, further comprising:
receiving, by the first computing system, an indication that the second content has been consumed from the client device; and
causing, at least in part by the first computing system, a first view to be rendered by the client device, the first view indicating that the first content is being loaded.

12. A first computing system, comprising:
at least one processor; and
at least one computer-readable medium encoded with instructions which, when executed by the at least one processor, cause the first computing system to:
receive, from a client device via a network, a request to access first content;
initiate, in response to receiving the request, loading of the first content for the client device;
send, to the client device via the network, second content;
after receiving the request from the client device, send, to the client device via the network, a first instruction to cause the client device to present the second content while the first content is being loaded; and
cause the first content to be presented by the client device.

13. The first computing system of claim 27, wherein the at least one computer-readable medium is further encoded with additional instructions which, when executed by the at least one processor, further cause the first computing system to:
retrieve, using access credentials associated with a user operating the client device, the first data from an account of the user maintained by the second computing system;
determine that the first data is indicative of an event of the account and
generate, using the first data, the second content to be indicative of the event.

14. The first computing system of claim 13, wherein the at least one computer-readable medium is further encoded with additional instructions which, when executed by the at least one processor, further cause the first computing system to:
configure the second content to include at least one user interface element that is selectable to cause an action to be taken with respect to the account.

15. The first computing system of claim 14, wherein the at least one computer-readable medium is further encoded with additional instructions which, when executed by the at least one processor, further cause the first computing system to:
receive, from the client device, an indication that the at least one user interface element has been selected; and
cause, in response to the indication, the action to be taken with respect to the account.

16. The first computing system of claim 12, wherein the at least one computer-readable medium is further encoded with additional instructions which, when executed by the at least one processor, further cause the first computing system to:
determine an estimated load time for the first content to be renderable by the client device; and
after receiving the request from the client device, select the second content based at least in part on the estimated load time for the first content and an estimated consumption time for the second content.

17. (canceled)

18. The first computing system of claim 12, wherein the at least one computer-readable medium is further encoded with additional instructions which, when executed by the at least one processor, further cause the first computing system to:
receive an indication that the second content has been consumed from the client device; and
in response to the indication, send, to the client device, a second instruction to cause the client device to present third content, third content while the first content is being loaded.

19. A method, comprising:
sending, from a client device to a first remote computing system via a network, a request to access first content that is accessible via the first remote computing system;
receiving, by the client device and from the first remote computing system via the network, second content;
after sending the request to the first remote computing system, receiving, by the client device and from the first remote computing system via the network, an instruction to present the second content on the client device while the first content is being loaded by the first remote computing system;
presenting, by the client device and based at least in part on the instruction, the second content; and
presenting, by the client device and after the first content has been loaded by the first remote computing system, the first content.

20. The method of claim 19, further comprising:
rendering, by the client device, a first graphical user interface (GUI) indicating that the first content is accessible via the first remote computing system; and
rendering, by the client device, a second GUI indicating, at least in part, that the first content is being loaded;
wherein presenting the second content includes presenting, by the client device, a third GUI providing the second content, and presenting the first content includes presenting, by the client device, a fourth GUI providing the first content.

21. The method of claim 1, further comprising:
after receiving the request from the client device, determining, by the first computing system, to cause the client device to present the second content while the first content is being loaded.

22. The method of claim 1, further comprising:
receiving, by the first computing system and from a second computing system via the network, first data indicative of the second content.

23. The method of claim 2, wherein the first computing system retrieves the first data from the account using an application programming interface (API) of the second computing system.

24. The method of claim 1, wherein the first computing system sends the second content to the client device after the first computing system receives the request.

25. The method of claim 4, wherein causing the action to be taken with respect to the account comprises:
instructing, by the first computing system and using the access credentials, the second computing system to add second data indicative of the action to the account.

26. The first computing system of claim 12, wherein the at least one computer-readable medium is further encoded with additional instructions which, when executed by the at least one processor, further cause the first computing system to:
after receiving the request from the client device, determine to cause the client device to present the second content while the first content is being loaded.

27. The first computing system of claim 12, wherein the at least one computer-readable medium is further encoded with additional instructions which, when executed by the at least one processor, further cause the first computing system to:
receive, from a second computing system via the network, first data indicative of the second content.

28. The first computing system of claim 13, wherein the at least one computer-readable medium is further encoded with additional instructions which, when executed by the at least one processor, further cause the first computing system to:
retrieve the first data from the account using an application programming interface (API) of the second computing system.

29. The first computing system of claim 12, wherein the at least one computer-readable medium is further encoded with additional instructions which, when executed by the at least one processor, further cause the first computing system to:
send the second content to the client device after the first computing system receives the request.

30. The first computing system of claim 15, wherein the at least one computer-readable medium is further encoded with additional instructions which, when executed by the at least one processor, further cause the first computing system to:
cause the action to be taken with respect to the account at least in part by instructing, using the access credentials, the second computing system to add second data indicative of the action to the account.
